(19) United States
(12) Patent Application Publication
(10) Pub. No.: US 2013/0258034 A1
(43) Pub. Date: Oct. 3, 2013

(54) In-Mold Labeling

(71) Applicants: Robert Joseph Devlin, Chicago, IL (US); Vladislav Valentinov Dimitrov, Des Plaines, IL (US); Scott Ryan Jackson, Morton Grove, IL (US); Jerry John Handzlik, Saint Charles, IL (US); James Scott Adams, Arlington Heights, IL (US); Michael Lee Horn, Round Lake, IL (US)

(72) Inventors: Robert Joseph Devlin, Chicago, IL (US); Vladislav Valentinov Dimitrov, Des Plaines, IL (US); Scott Ryan Jackson, Morton Grove, IL (US); Jerry John Handzlik, Saint Charles, IL (US); James Scott Adams, Arlington Heights, IL (US); Michael Lee Horn, Round Lake, IL (US)

(73) Assignee: DEVLINKS, LTD., Arlington Heights, IL (US)

(21) Appl. No.: 13/436,863

(22) Filed: Mar. 31, 2012

(51) Int. Cl. B41J 2/47; B28B 13/00

(52) U.S. Cl. 347/225; 425/504

(57) ABSTRACT

A disclosed method relates to creating labels for in-mold labeling. A first portion is advanced from rolled labeling material to a label making area of an in-mold labeling apparatus. First label information is printed on the first portion. The first portion is cut by applying a first laser beam to the first portion based on a first pattern. A second portion is advanced from the rolled labeling material to the label making area. Second label information is printed on the second portion. The second portion is cut by applying a second laser beam to the second portion based on a second pattern. The second pattern can be different from the first pattern.

### BACKGROUND

Injection molding is a process for producing manufactured products from a resin material, such as thermoplastic or thermosetting plastic material. After the product is designed, a mold is created, usually from a metal such as steel or aluminum. The mold is precision-machined to form the features of the product. To create the product, the resin material is heated and forced by injection into the mold cavity, where it cools and conforms to the configuration of the mold cavity.

In-mold labeling is a process by which a product's label is secured to the product during the molding process, so that the label becomes an integral part of the product. During the in-mold labeling process, tooling can transfer the label to the mold and align it in the mold cavity prior to the introduction of resin material.

### SUMMARY

In some implementations, a method is provided. The method comprising making a first label and a second label for use in a molding assembly of an in-mold labeling apparatus. Making the first label comprises (i) advancing a first portion from rolled labeling material to a label making area of the in-mold labeling apparatus, (ii) printing first label information on the first portion, and (iii) cutting the first portion by at least applying a first laser beam to the first portion based on a first pattern. Making the second label comprises (i) advancing a second portion from the rolled labeling material to the label making area, (ii) printing second label information on the second portion, and (iii) cutting the second portion by at least applying a second laser beam to the second portion based on a second pattern. In this method, the second pattern is different from the first pattern.

In some implementations, an apparatus is provided. The apparatus comprises a printer roll assembly, a printer assembly, and a laser device assembly. The printer roll assembly is configured to receive rolled labeling material. The printer assembly includes a printer. The printer is configured to print at least one of a plurality of different labels onto a portion of the labeling material. The laser device assembly is configured to provide a laser beam to cut the portion into a cut portion for insertion into a mold cavity. The laser device assembly is programmable to cut a plurality of shapes.

In some implementations, a computer system is provided. The computer system comprising one or more non-transitory computer-readable mediums and program instructions. The program instructions are stored to the one or more mediums. The program instructions are executable by one or more processors to cause an in-mold labeling apparatus to perform functions comprising: (i) advancing a labeling portion from rolled labeling material to a cutting area of the in-mold labeling apparatus, (ii) controlling a laser beam to cut the labeling portion based on a pattern received by the computer system, wherein cutting the labeling portion comprises applying the laser beam to the labeling portion, and (iii) performing an in-mold labeling using the labeling portion.

### BRIEF DESCRIPTION OF THE FIGURES

FIG. 1 illustrates a functional block diagram of an in-mold labeling apparatus, according to some embodiments.

FIG. 2 illustrates a perspective view of an in-mold labeling apparatus, according to an embodiment.

FIG. 3A illustrates an enlarged perspective view of a portion of a label making station, according to an embodiment.

FIG. 3B illustrates a front elevation view of the portion of the label making station.

FIG. 4 illustrates a perspective view of a roll feeder assembly, according to an embodiment.

FIGS. 5A and 5B illustrate a laser assembly, according to an embodiment.

FIGS. 6A and 6B illustrate a pick and place assembly, according to an embodiment.

FIG. 7 illustrates a transfer portion of a robotic arm assembly, according to an embodiment.

FIG. 8 illustrates a method for creating labels for in-mold labeling, according to some embodiments.

FIG. 9 illustrates a method for in-mold labeling, according to an embodiment.

FIG. 10 illustrates a functional block diagram of an exemplary computer system.

FIG. 11 illustrates a conceptual partial view of an exemplary computer program product.

### DETAILED DESCRIPTION

### Functional Block Diagram of In-Mold Labeling Apparatus

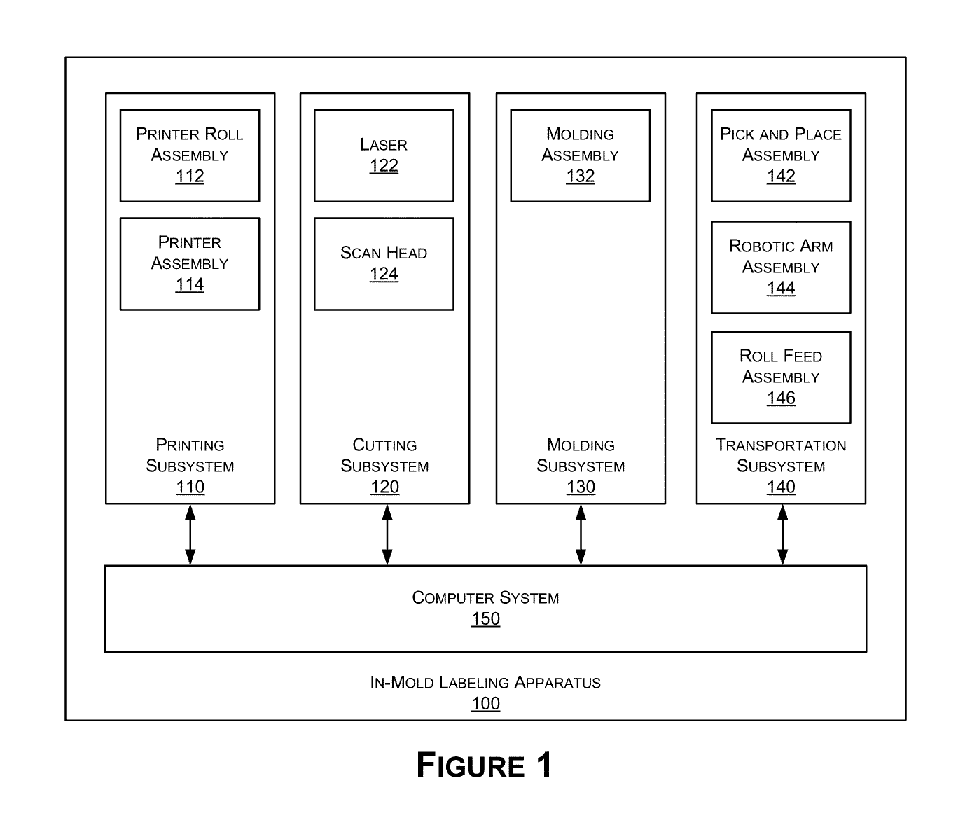

FIG. 1 illustrates a functional block diagram of an in-mold labeling apparatus 100, according to some embodiments. The in-mold labeling apparatus 100 can be configured to perform part of an in-mold labeling process or an entire in-mold labeling process. Generally, the in-mold labeling process can produce a part that includes an integrated label (or multiple labels). The in-mold labeling process can use various molding processes, such as injection molding, blow molding, or thermoforming, among others. In some implementations, the in-mold labeling process can use combinations of these molding processes.

As shown in FIG. 1, the in-mold labeling apparatus 100 can include a number of systems or subsystems, such as, for example, one or more of each of the following: a printing subsystem 110, a cutting subsystem 120, a molding subsystem 130, a transportation subsystem 140, and a computer system 150. Systems and subsystems are shown and described mainly for ease of discussion, and the assembles or subsystems shown may actually be part of other systems or subsystems, not part of any system or subsystem, or not present at all.

The printing subsystem 110 can include a printer roll assembly 112 and a printer assembly 114. The printer roll assembly 112 can be configured to receive rolled labeling material. The rolled labeling material can include one or more rolls of labeling material. The labeling material can be formed of any suitable material, such as polypropylene or polystyrene, among other types. The labeling material can be coated with a heat seal layer, depending on the desired implementation. In addition, the labeling material can be coated with a substrate material to which heat resistant ink can be applied, depending on the desired implementation.

The printer roll assembly 112 can be configured to receive one or more rolls of various types and sizes. In some embodiments, the printer roll assembly 112 can receive a first type of roll and a different second type of roll. For example, the first roll of labeling material can be formed of polypropylene material, and the second roll of labeling material can be formed of polystyrene material. As another example, the first roll can include labeling material of a first size, and the second roll can include labeling material of a different second size. Other possibilities exists as well.

The printer roll assembly 112 can be further configured to provide portions of the rolled labeling material to another portion of the printing subsystem 110, such as the printer assembly 114. For example, the printer roll assembly 112 can be coupled to a motor (not shown in FIG. 1). The motor can drive the printer roll assembly 112 to advance portions from a roll or from multiple rolls of labeling material. In an implementation, portions of labeling material can be advanced from one roll at a given time. In another implementation, portions of labeling material can be advanced from multiple rolls at a given time.

As mentioned above, the printing subsystem 110 can include a printer assembly 114. The printer assembly 114 can include one or more printers that are configured to print information to labeling material. The printer(s) can be of any suitable type. For example, the printer assembly 114 can include a thermal printer. The thermal printer can use technologies such as, for example, direct thermal printing or thermal transfer printing. One example of a suitable type of thermal printer is manufactured by Zebra Technologies, having model number 170xi4. Of course, the printer assembly 114 can include other types of printers. Another example of a suitable type of printer is manufactured by Intermec Technologies Corporation, having model number PM4i. Yet another example of a suitable type of printer is manufactured by QuickLabel Systems, having product name VIVO!® Touch. Other possibilities exist as well. The printer assembly 114 can include a laser printer, an ink jet printer, or both. The printer assembly 114 can include one or more color printers, monochrome printers, or printers adapted to print in color and monochrome modes, among other types of printers.

The printer assembly 114 can receive portions of labeling material from the printer roll assembly 112. For example, portions of the labeling material can be advanced one portion at a time to a printing area of the printer assembly 114. In this example, a printer of the printer assembly 114 can print information to the portion of the labeling material that is in the printing area. As another example, portions of the labeling material can be advanced multiple portions at a time to the printing area of the printer assembly 114. In this example, one or more printers of the printer assembly 114 can print labeling information to the portions when the portions are in the printing area. In this way, labeling information can be printed to labeling material in a parallel fashion. Other possibilities exists as well.

The printer(s) of the printer assembly 114 can be configured to receive data from the computer system 150 and to print labeling information based on the data. The printer(s) of the printer assembly 114 can be adapted to print various types of labeling information, including one or more images, text portions, barcodes, dates, lot numbers, and the like. The labeling information can include combinations of these and/or other types of labeling information.

In some implementations, the printer(s) of the printer assembly 114 can print the same labeling information to each portion of the labeling material that advances through the printing area. For example, a printer of the printer assembly 114 can print the same image to each portion of the labeling material that advances through the printing area. In some implementations, the printer(s) of the printer assembly 114 can print different types of labeling information to different portions of the labeling material. For example, a printer of the printer assembly 114 can alternate between printing a first image and a second image. As another example, a printer of the printer assembly 114 can print a first image for several portions of the labeling material, and can then print a second image for several subsequent portions of the labeling material. Other possibilities exist as well.

With continued reference to FIG. 1, the cutting subsystem 120 is generally adapted to cut portions of the labeling material. The cutting subsystem 120 includes a laser 122 and a scan head 124. The laser 122 can include one more suitable types of lasers. The laser 122 can include, for example, a CO₂ laser having a suitable output range for cutting portions of labeling material. For example, one such laser device is manufactured by Synrad Inc., having model number FSF100KD. Other possibilities exist as well.

The scan head 124 can be adapted to redirect laser beams emitted from the laser 122. For example, one such scan head is manufactured by SCANLAB AG, having model name SCANcube® 14. Other possibilities exist as well. The scan head 124 can be adapted to receive cutting patterns from the computer system 150 and, based on the desired cutting pattern, redirect a laser beam toward a target portion of labeling material. The cutting patterns can take the form of computer-readable instructions. For example, the scan head 124 can receive a cutting pattern that indicates that the scan head 124 is to redirect a laser beam in a rectangular pattern. In this example, the cutting pattern can further indicate the size of the rectangular pattern. Accordingly, based on the cutting pattern, the scan head 124 can redirect the laser beam to cut a portion of labeling material disposed at a target area.

A cutting pattern can be of various shapes, depending on the desired implementation. The shapes include regular shapes, such as a rectangle or a circle. In addition, the shapes include irregular shapes, which includes any shape that can be used in a desired manner on a given part or in a given mold. For example, an irregular shape can include a non-symmetrical shape. As another example, an irregular shape can include a shape that has a symmetry but includes one or more curved or otherwise irregular features. Other possibilities exist as well.

With continued reference to FIG. 1, the molding subsystem 130 is generally configured to mold a part by integrating one or more cut portions of labeling material (or simply “labels”) such that the label is used as a portion of the molded part. To this end, the molding subsystem 130 can use various types of molding processes, such as injection molding, blow molding, or thermoforming. The molding subsystem 130 includes a molding assembly 132. The configuration of the molding assembly 132 can depend on the type(s) of molding processes utilized by the molding subsystem 130. For example, assume that the molding subsystem 130 utilizes injection molding. In this example, the molding assembly 132 can include one or more molds having cavities. Each mold can be adapted to receive one or more labels. The molding assembly 132 can be configured to feed a moldable material into the mold cavity such that the material takes the shape of the cavity upon cooling. In this example, the label(s) in the cavity can become integrally formed with the cooled material. This example is merely illustrative; the molding assembly 132 can have various other forms.

With continued reference to FIG. 1, the transportation subsystem 140 is generally configured to move parts and/or labels throughout the in-mold labeling apparatus 100. The transportation subsystem 140 can include a pick and place assembly 142, a robotic arm assembly 144, and a roll feed assembly 146, although some or all of these assemblies may not be present in other embodiments. The transportation subsystem 140 can include various other suitable mechanisms for moving parts and/or labels throughout the in-mold labeling apparatus 100, as well.

With continued reference to FIG. 1, the computer system 150 is adapted to control components of some or all of the printer subsystem 110, the cutting subsystem 120, the molding subsystem 130, the transportation subsystem 140, and/or any other component or additional system or subsystem of the in-mold labeling apparatus 100. The computer system 150 can include any suitable number of controllers and/or computing devices. In some implementations, the computer system 150 can include one or more programmable logic controllers (PLCs). Some examples of some suitable PLCs are manufactured by Rockwell Automation, Inc. A PLC used in connection with the computer system 150 can operate by itself or with another controller and/or computing device. For example, the computer system 150 can include a PLC that operates in connection with a general-purpose computer.

To this end, the computer system 150 is adapted to provide instructions to and/or receive instructions from various components of the in-mold labeling apparatus 100. As an example, the computer system 150 can be adapted to provide instructions to the scan head 124 of the cutting subsystem 120. The computer subsystem 150 can, for example, provide cutting patterns to the scan head 124 to indicate how the scan head 124 is to redirect laser beams toward a target cutting area. As another example, the computer system 150 can be adapted to provide labeling information to the printer assembly 114. Accordingly, printer(s) of the printer assembly 114 can use the labeling information to print labeling information to portions of the labeling material. These examples are merely illustrative. The computer system 150 can be adapted to control components of the in-mold labeling apparatus 100 in various other ways.

### In-Mold Labeling Apparatus

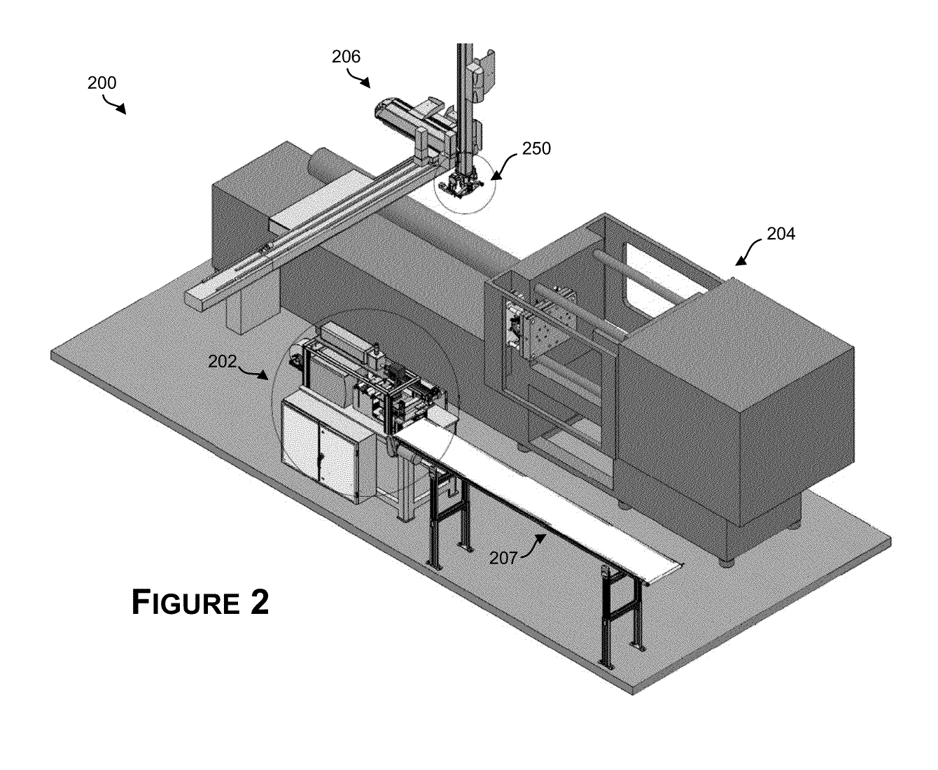

FIG. 2 illustrates a perspective view of an in-mold labeling apparatus 200, according to an embodiment. The in-mold labeling apparatus 200 can include a label making station 202, a molding station 204, a robotic arm assembly 206, and a conveyor 207. The label making station 202 is generally adapted to make labels for use in an in-mold labeling process. The molding station 204 is generally adapted to perform in-mold labeling processes. The robotic arm assembly 206 is generally adapted to deliver labels from the label making station 202 to the molding station 204, and is further adapted to deliver in-mold labeled parts from the molding station 204 to the label making station 202. The conveyor 207 is generally adapted to receive and transport in-mold labeled parts.

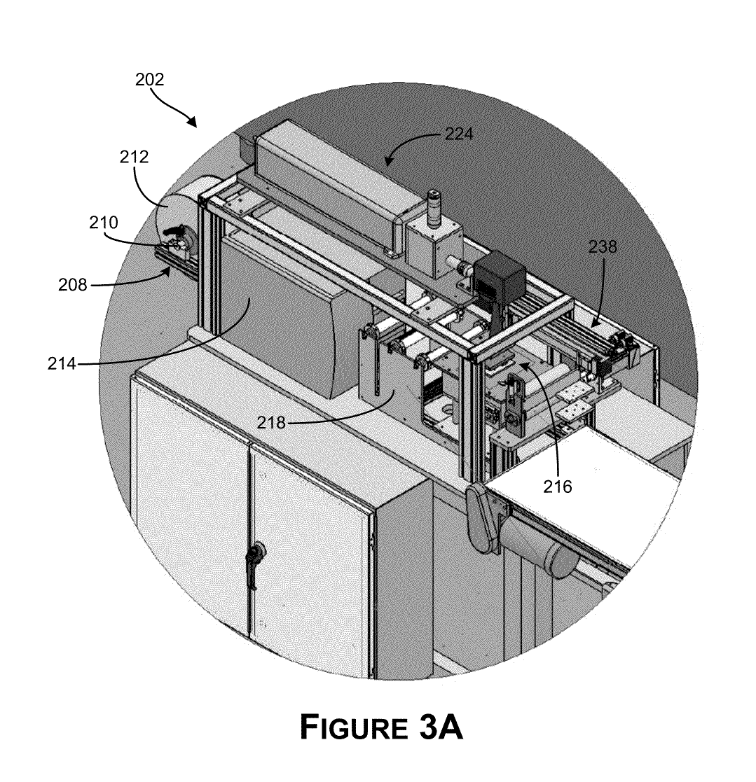

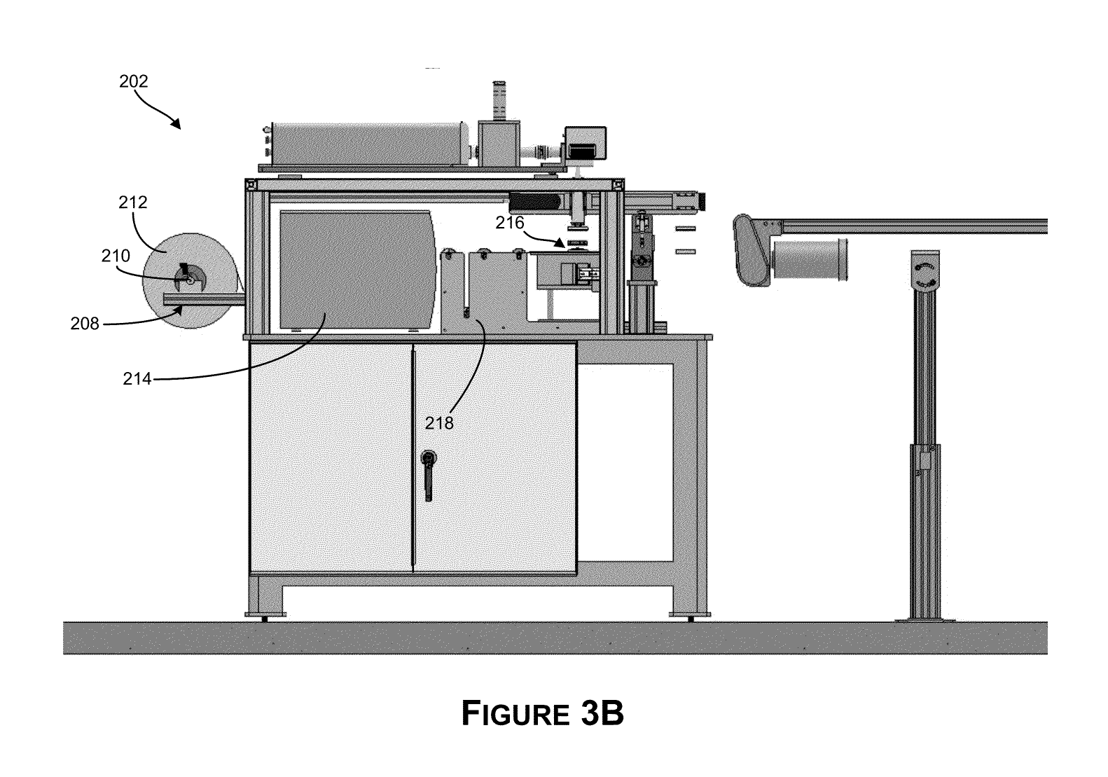

FIG. 3A illustrates an enlarged perspective view of a portion of the label making station 202 of the in-mold labeling apparatus 200. FIG. 3B illustrates a front elevation view of the portion of the label making station 202. As shown in FIGS. 3A and 3B, the label making station 202 can include a printer roll assembly 208. The printer roll assembly 208 includes a spindle 210. Rolled labeling material 212 is provided on the spindle 210. The labeling material 212 can include any suitable type of labeling material. Examples of suitable types of labeling material include polypropylene and polystyrene. In addition, the labeling material 212 can include blank material or pre-printed material. The printer roll assembly 208 is configured to advance portions of the roll of labeling material 212 into the label making station 202. For example, the printer roll assembly 208 can be coupled to a motor (not shown) that rotates the spindle 210 and thereby advances portions of the labeling material 212 into the label making station 202.

The printer roll assembly 208 is shown to be provided with a single roll of labeling material. In some implementations, a printer roll assembly can be provided with multiple rolls of labeling material.

In addition, the printer roll assembly 208 is shown to be provided with a blank roll of labeling material. In some implementations, a printer roll assembly can be provided with a roll of material having printed information. For example, some or all label information can be printed on the roll of material before the roll of material is provided to the printer roll assembly 208.

Further, the label making station 202 is shown to utilize the printer roll assembly 208. In some implementations, a label making station can include a different type of assembly for receiving labeling material. For example, a label making station can include an assembly that receives a stack of pre-cut labels of one or more sheets of labeling material.

With continued reference to FIGS. 3A and 3B, labeling material from the roll 212 can be advanced into the label making station 202 toward a printing area. A printer 214 can be disposed in the printing area. The printer 214 is configured to print label information on portions of the labeling material. The printer 214 can print any suitable type of label information to the labeling material 212. Examples of suitable types of label information include images, text, barcodes, dates, lot numbers, and the like. The label information can be printed in color, monochrome, or the like. The printer 214 can receive the label information from a suitable computer system (not shown in FIGS. 3A and 3B). For example, a computer system can store and send the label information to the printer in the form of an image file, such as a JPEG (“Joint Photographic Experts Group”) file, a bitmap file, or the like.

The printer 214 can be adapted to print different types of label information to different portions of the labeling material 212. For example, when a first portion of the labeling material 212 is advanced to the printer 214, the printer 214 can print a first image, for example, to the first portion. Then, when a second portion of the labeling material 212 is advanced to the printer 214, the printer can print a second image, for example, to the second portion. As another example, the printer 214 can print a first image, for example, to a first batch of the labeling material 212 and, accordingly, can print the first image to several or more consecutive portions of the labeling material 212. After printing the first image to the batch, the printer 214 can print a second image, for example, to a second batch of the labeling material 212 and, accordingly, can print the second label information to several or more consecutive portions of the labeling material 212.

The printer 214 can be adapted to print label information of different sizes to different portions of the labeling material. For example, the printer 214 can print first label information of a first size to one or more portions of the labeling material 212. The printer 214 can then print second label information of a second size to one or more portions of the labeling material 212. As another example, the printer 214 can print label information in a first size to one or more portions of the labeling material 212, and can then print the same label information in a second size to one or more subsequent portions of the labeling material 212.

The printer 214 can be adapted to print label information of different shapes to different portions of the labeling material 212. For example, the printer 214 can print first label information of a first shape (for example, a rectangular image) to one or more portions of the labeling material 212. The printer 214 can then print second label information of a second shape (for example, a circular image) to one or more portions of the labeling material 212.

In other words, the printer 214 can be programmed as needed to print label information in an efficient, flexible way to meet the demands of a variety of label, mold types, and projects. In addition, some embodiments or implementations may not include or may not use a printer. For example, in some implementations, some or all label information can be printed on the roll of material before the roll of material is provided to the printer roll assembly 208.

FIGS. 3A and 3B show the label making station 202 to include a single printer. In some implementations, a label making station can include multiple printers.

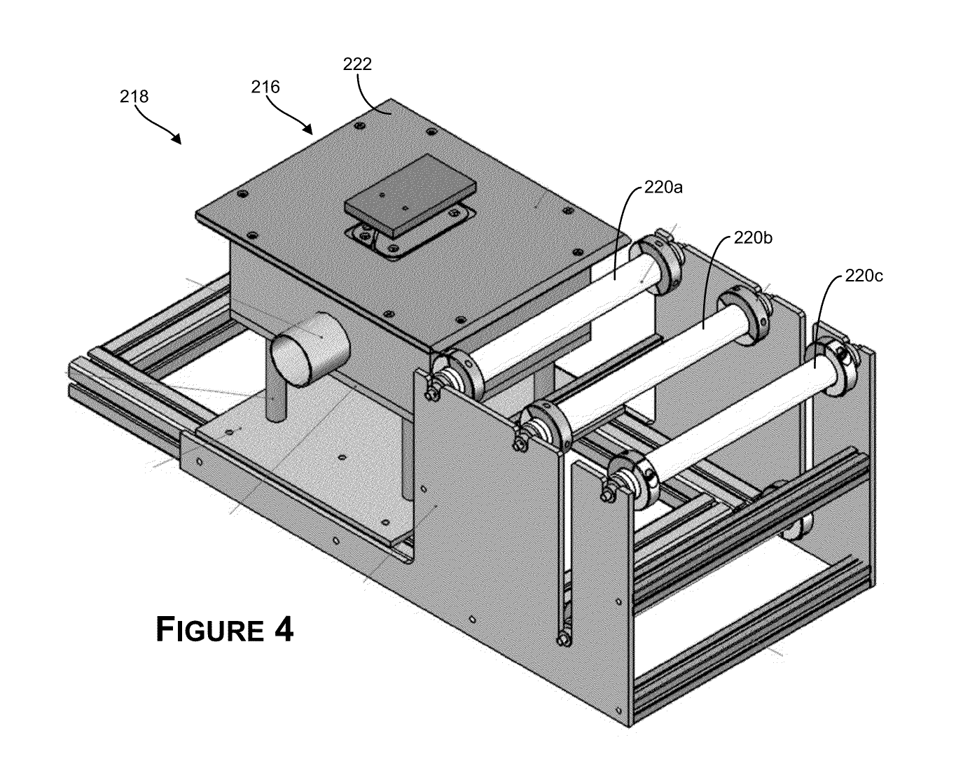

With continued reference to FIGS. 3A and 3B, labeling material from the roll 212 is advanced from the printing area to a cutting area 216 by way of a roll feeder assembly 218. FIG. 4 illustrates a perspective view of the roll feeder assembly 218. As shown in FIG. 4, the roll feeder assembly 218 is oriented opposite as shown in FIGS. 2-3A and includes several rollers 220a-220c that are adapted to guide the labeling material to a laser plate 222. One such roller is manufactured by Misumi USA, having part number HRJA30.

In the embodiment shown in FIG. 4, the laser plate 222 serves as the cutting area 216. In some embodiments, the cutting area can be separate from the roll feeder assembly.

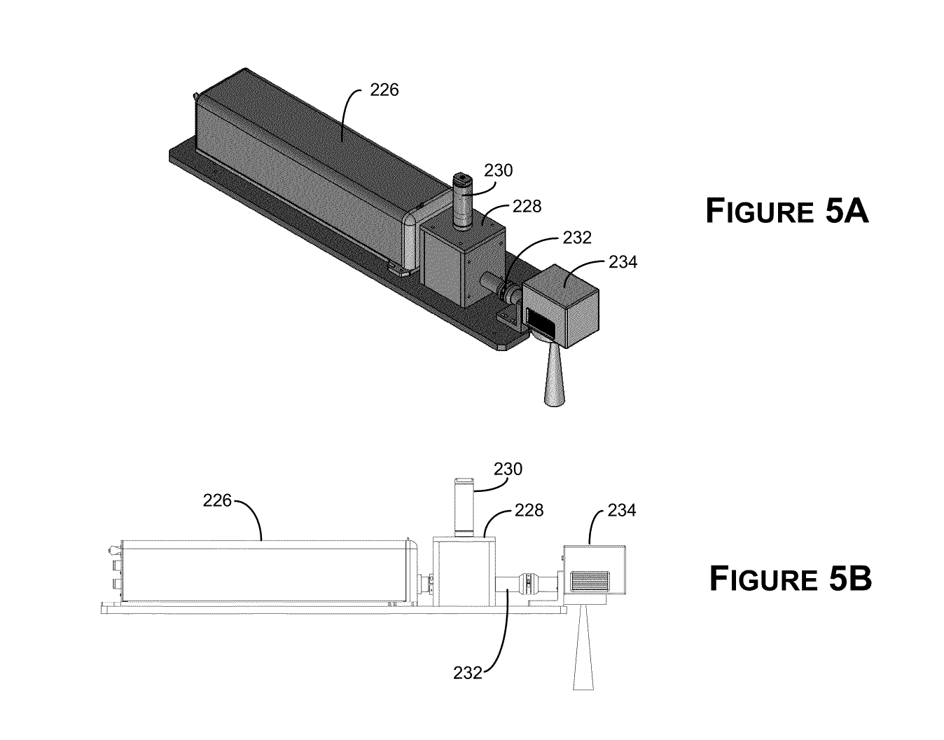

With reference to FIGS. 3A and 3B, a laser assembly 224 can be disposed above the cutting area 216. The laser assembly 224 can be generally configured to cut a portion of the labeling material that is advanced to the cutting area 216. FIGS. 5A and 5B illustrate perspective and front elevation views of the laser assembly 224. As shown in FIGS. 5A and 5B, the laser assembly 224 includes a laser device 226, a beam dump apparatus 228, a collimator 232, and a scan head 234.

The laser device 226 can be adapted to generate a laser beam having a suitable output range. In an embodiment, the laser device 226 can be a sealed CO₂ laser having an output range from 10 to 200 watts. One such laser device is manufactured by Synrad Inc., having model number FSF100KD.

The beam dump apparatus 228 can be adapted to selectively absorb laser beams directed at the beam dump apparatus 228. One such beam dump apparatus is manufactured by Kentek Corporation, having product number ABD-0.75. As shown in FIGS. 5A and 5B, the beam dump apparatus 228 can be coupled to an emergency stop actuator 230. Actuation of the emergency stop actuator 230 can activate the beam dump apparatus 228 such that the beam dump apparatus 228 absorbs laser beams directed at the beam dump apparatus 228.

The collimator 232 can be adapted to change the size a laser beam directed at the collimator 232. For example, one such collimator is manufactured by Laser Mechanisms, Inc., having part number PLCOL0110. The collimator 232 can be adapted to increase the size of the laser beam. In this way, the collimator 232 can serve as a beam expander or, in other words, an up-collimator. Generally, beam collimation can be useful for creating a desired laser spot size or for controlling a diameter of the laser beam over relatively long distances.

The scan head 234 can be adapted to redirect laser beams received from the collimator 232. For example, one such scan head is manufactured by SCANLAB AG, having model name SCANcube® 14. The scan head 234 can have a beam entrance side in which a laser beam enters the scan head 234. The scan head 234 can have a beam exit side in which laser beams exit the scan head 234. In the embodiment shown in FIGS. 5A and 5B, the beam entrance side is the side that is coupled to the collimator 232, and the beam exit side is the bottom side of the scan head 234. In FIGS. 5A and 5B, a representation 236 of a laser beam is shown to be exiting from the beam exit side.

The scan head 234 can be adapted to receive and/or store one or more cutting patterns from a computer system (not shown in FIGS. 5A and 5B). The cutting patterns can provide instructions for the scan head 234 to redirect received laser beams toward the cutting area 216. In some implementations, the laser assembly 224 can include a controller that can be adapted to control one or more operations of the scan head 234. The controller can instead be part of a different assembly or can be a stand-alone controller. In some implementations, the scan head 234 can include a control board that provides an interface with a computer, such as, for example, a general-purpose computer. For example, one such control board is manufactured by SCANLAB AG, having the model name RTC® 4 PC Interface Board. Another example of a suitable control board is also manufactured by SCANLAB AG, having model name RTC® 5 PC Interface Board. In addition, any suitable software may be used to control one or more operations of the scan head 234. One such example of software is manufactured by SCAPS GmbH, having model name SAMLight. These examples are merely illustrative; other possibilities exist as well.

During a cutting operation, the laser device 226 can generate a laser beam. The laser beam can pass through the beam dump apparatus 228 and the collimator 232 into the scan head 234. The scan head 234 can receive the laser beam and, based on a cutting pattern, redirect the beam toward the cutting area 216. Accordingly, the laser assembly 224 can be used to cut a portion of the labeling material advanced from the roll 212.

In some implementations, the laser assembly 224 can be configured to cut different label shapes. For example, the laser assembly 224 can be configured to cut labels for parts having different sizes. Accordingly, differently sized parts can be produced using a single in-mold labeling apparatus. In addition, in some implementations, the laser assembly 224 can be programmable to adjust label shapes. Accordingly, the laser assembly 224 can provide flexibility for adjusting a shape of a label, enabling an operator to easily configure label quality. For example, an operator can cause the laser assembly 224 to slightly adjust a shape of a label to be created so that the label has a better integral fit with a molded part. In some implementations, the adjustment can be performed automatically using a computer system.

In some implementations, the laser assembly 224 can include multiple scan heads. For example, the laser assembly 224 can include a laser device that can direct a laser beam toward a beam splitter. The beam splitter can split the beam and direct each of the resulting beams toward a different scan head. Each of the scan heads can redirect the respective resulting beam toward a target area. In some implementations, each of the scan heads can redirect the respective beam toward a different target area. By incorporating a laser device with multiple scan heads in this way, a label making area can include multiple cutting areas that can operate in a parallel fashion. In some implementations, each of the scan heads can redirect the respective beam toward the same target area. These examples are merely illustrative; other possibilities exist as well.

In some implementations, the laser assembly 224 can be used to burn or otherwise imprint information onto a portion of labeling material. For example, the scan head 234 can be adapted or controlled to redirect a laser beam from the laser assembly 224 toward a target area, thereby burning information onto a portion of labeling material disposed at the target area. The information can include, for example, a product identifier or another type of registration code.

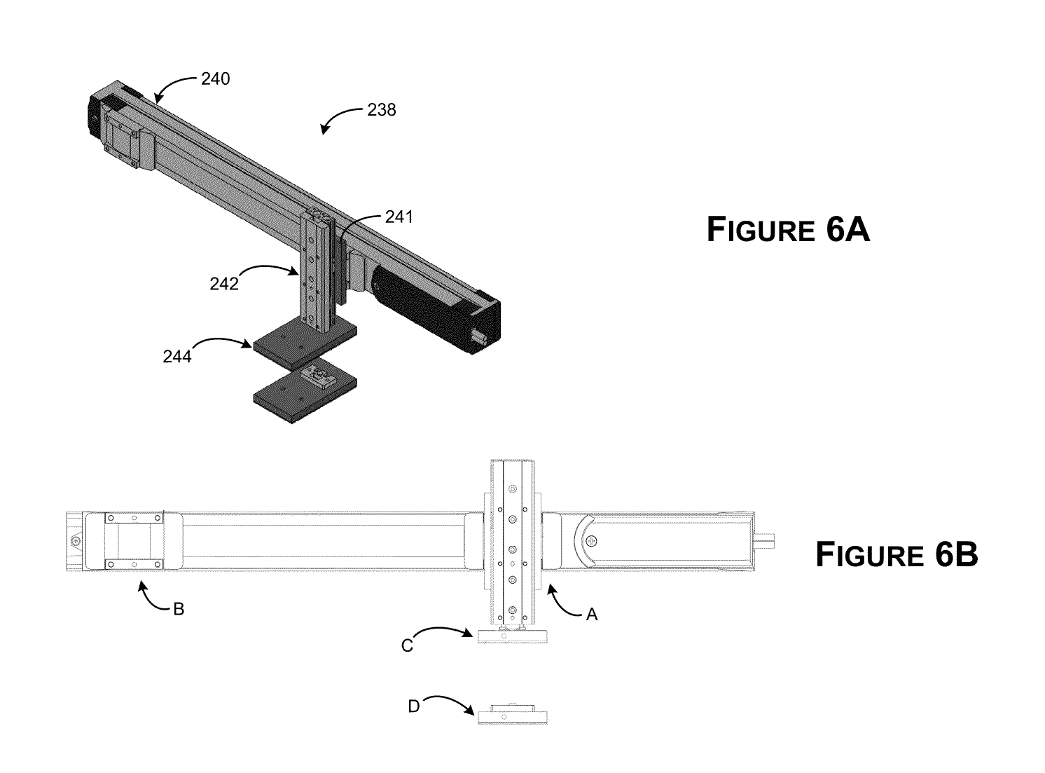

With reference to FIGS. 6A and 6B, after the laser assembly 224 is used to cut a portion of the labeling material, a pick and place assembly 238 can be used to pick up the cut portion and move the cut portion to the molding station 204 (shown in FIG. 2). FIGS. 6A and 6B show perspective and front elevation views of the pick and place assembly 238, which is oriented opposite as shown in FIGS. 2 and 3A. As shown in FIGS. 6A and 6B, the pick and place assembly 238 can include a first slide assembly 240, a second slide assembly 242, and a vacuum pad 244. One such first slide assembly is manufactured by Misumi Corporation, having part name Single Axis Robot RS3. A portion 241 is slidably attached to the first slide assembly 240. The first slide assembly 240 can be adapted to slide the portion 241 along a first axis, from a first position (represented in FIGS. 6A and 6B as indicator “A”) to a second position (represented as indicator “B”), and vice versa. In FIGS. 6A and 6B, a representation of the portion 241 is shown at position “A” and the portion 241 is shown at position “B” in connection with the second slide assembly 242. The vacuum pad 244 is attached to the second slide assembly 242. The first position B is a position that is above the cutting area 216 of the label making station 202. The second position A is a hand-off position (to be discussed in more detail below).

The second slide assembly 242 can be adapted to move the vacuum pad 244 along a second axis, from a first position (represented in FIGS. 6A and 6B as indicator “C”) to a second position (represented in FIGS. 6A and 6B as indicator “D”), and vice versa. The second slide assembly 242 can be provided with a suction source, such as an air cylinder (not shown), to create suction at the vacuum pad 244. When the first slide assembly is positioned at position A, the pick and place assembly 238 can lower the second slide assembly to position D. The suction of the vacuum pad 244 can press a cut portion of the labeling material against the vacuum pad 244. The pick and place assembly 238 can then raise the second slide assembly to position C and slide the portion 241 to position B.

At position B, the pick and place assembly 238 can transfer the cut portion of the labeling material to the robotic arm assembly 206 (shown in FIG. 2). As shown in FIG. 2, the robotic arm assembly 206 can include a transfer portion 250. The transfer portion 250 can be adapted to receive labels from the pick and place assembly 238. In particular, the robotic arm assembly 206 can move the transfer portion 250 to a position near the pick and place assembly 238. For example, the robotic arm assembly 206 can move the transfer portion 250 below the pick and place assembly 238. The pick and place assembly 238 can then transfer the labels to the transfer portion 250.

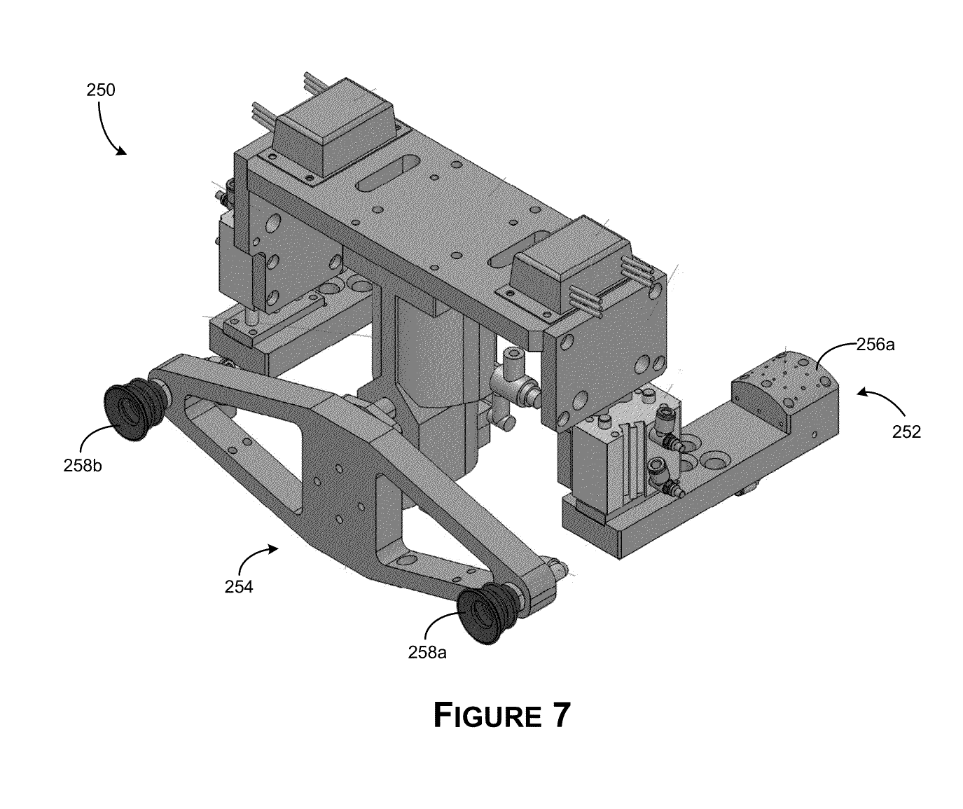

FIG. 7 shows an enlarged perspective view of the transfer portion 250. In one embodiment, the transfer portion 250 is configured to transfer cut labeling material (or simply “labels”) from the label making station 202 to the molding station 204. The transfer portion 250 can further be configured to transfer an in-mold labeled part from the molding station 204 to another component, assembly, or portion of the apparatus, such as conveyor 207 disposed near the label making station 202. As shown in FIGS. 7A and 7B, the transfer portion 250 can include a label holding portion 252 and a part holding portion 254. The label holding portion 252 includes two vacuum blocks 256a and 256b (not shown). The vacuum blocks 256a and 256b are each adapted to transport a label from the label making station 202 to the molding station 204 while generating suction to prevent the labels from falling off the vacuum blocks 256a and 256b.

The transfer portion 250 can also be adapted to transfer in-mold labeled parts from the molding station 204 to the conveyor 207 disposed near the label making station 202. In particular, the part holding portion 254 of the transfer portion 250 can include two suction portions 258a and 258b. The suction portions 258a and 258b can be adapted to generate a suction to hold in-mold labeled parts while the transfer portion 250 transfers the parts from the molding station 204 to the conveyor 207. The transfer portion discussed and depicted is an example only; other examples and arrangements are possible as well.

Methods for Creating Labels for in-Mold Labeling

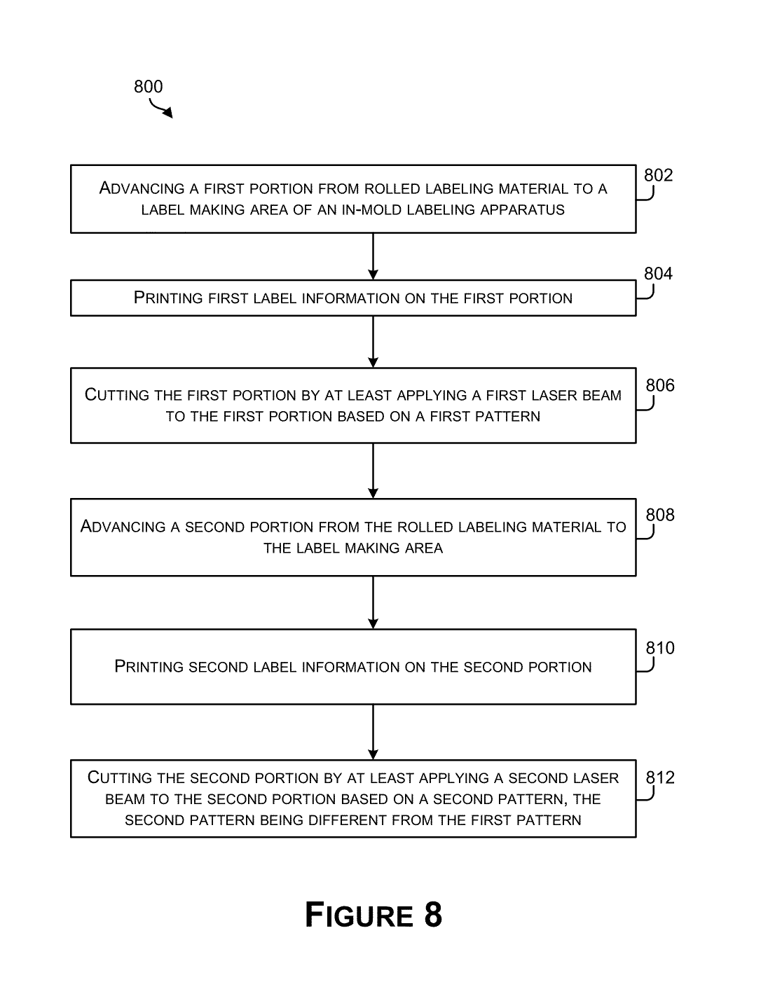

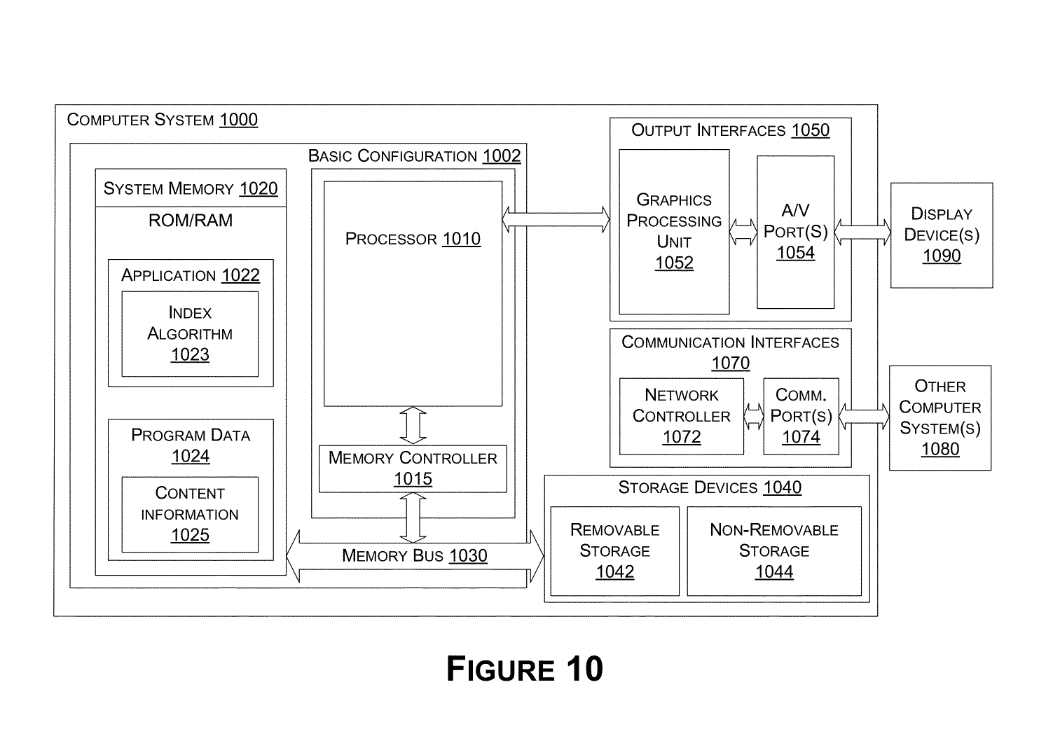

FIG. 8 illustrates a method 800 for creating labels for in-mold labeling, according to some embodiments. The method 800 can be performed, for example, in connection with the in-mold labeling apparatus 100 shown in FIG. 1 or the in-mold labeling apparatus 200 shown in FIG. 2. In addition, the method 800 can be performed, for example, in connection with the computer system shown in FIG. 10 (described in detail below). The method 800 can also be performed in connection with another in-mold labeling apparatus and/or another computer system.

Blocks 802, 804, and 806 constitute making a first label for use in a molding assembly of an in-mold labeling apparatus. At block 802, the method 800 includes advancing a first portion from rolled labeling material to a label making area of the in-mold labeling apparatus. At block 804, the method 800 includes printing first label information on the first portion. At block 806, the method 800 includes cutting the first portion by at last applying a first laser beam to the first portion based on a first pattern.

Blocks 808, 810, and 812 constitute making a second label for use in the molding assembly. At block 808, the method 800 includes advancing a second portion from the rolled labeling material to the label making area. At block 810, the method 800 includes printing second label information on the second portion. At block 812, the method 800 includes cutting the second portion by at least applying a second laser beam to the second portion based on a second pattern. In the method 800, the second pattern is different from the first pattern.

In some implementations, the method 800 includes applying the first laser beam along a perimeter of the first portion. In these implementations, the method 800 further includes applying the second laser beam along a perimeter of the second portion. In these implementations, the perimeter of the first portion can be different from the perimeter of the second portion.

In some implementations, in the method 800, the rolled labeling material includes a first roll and a second roll. In these implementations, the first portion can be from the first roll, and the second portion can be from the second roll.

In some implementations, in the method 800, the rolled labeling material includes a roll, and the first and second portions are from the roll.

In some implementations, in the method 800, the first portion is formed of a first material, the second portion is formed of a second material, and the first material is different from the second material.

In some implementations, the method 800 includes receiving shape information that is indicative of a shape of an object for use in the second in-mold labeling. In these implementations, the method 800 includes determining the second pattern based on the shape information.

In some implementations, in the method 800, the first label information is different from the second label information.

In some implementations, the method 800 includes performing an in-mold labeling using the cut first portion and the cut second portion.

In some implementations, in the method 800, making the first label and making the second label temporally overlap.

Methods for in-Mold Labeling

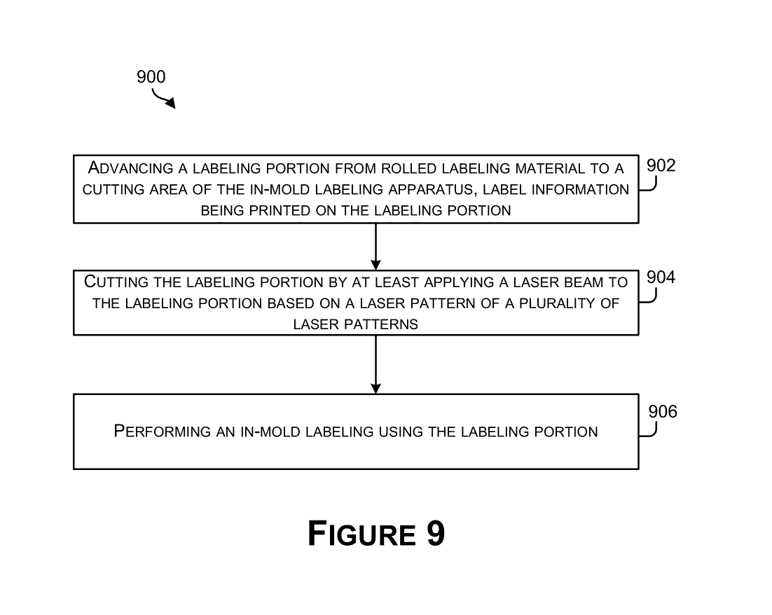

FIG. 9 illustrates a method 900 for in-mold labeling, according to some embodiments. The method 900 can be performed, for example, in connection with the in-mold labeling apparatus 100 shown in FIG. 1 or the in-mold labeling apparatus 200 shown in FIG. 2. In addition, the method 900 can be performed, for example, in connection with the computer system shown in FIG. 10 (described in detail below). The method 900 can be performed in connection with another in-mold labeling apparatus and/or another computer system.

At block 902, the method 900 includes advancing a labeling portion from rolled labeling material to a cutting area of an in-mold labeling apparatus. In the method 900, the label information is printed on the labeling portion, either before implementation of the method or during implementation of the method. At block 904, the method 900 includes controlling a laser beam to cut the labeling portion based on a pattern received by the computer system. In the method 900, cutting the labeling portion can include applying the laser beam to the labeling portion. At block 904, the method 900 includes performing an in-mold labeling using the labeling portion.

### Computer System

FIG. 10 illustrates a functional block diagram of an exemplary computer system 1000. The computer system 1000 can be used in connection with the in-mold labeling apparatus 100 shown in FIG. 1, the in-mold labeling apparatus 200 shown in FIG. 2, or another in-mold labeling apparatus.

The computer system 1000 can include various types of computing devices, such as a personal computer, server, mobile device, cellular phone, or tablet computer. The computer system 1000 can include multiple computing devices. For example, in connection with the in-mold labeling apparatus 200 shown in FIG. 2, the computer system 1000 can include a first computing device that is disposed at the label making station 202 and a second computing device that is disposed at the molding station 204. Depending on the desired implementation, the multiple computing devices can share operability or can run independently from one another. In a basic configuration 1002, the computer system 1000 can include one or more processors 1010 and system memory 1020. A memory bus 1030 can be used for communicating between the processor 1010 and the system memory 1020. Depending on the desired configuration, the processor 1010 can be of any type, including a microprocessor (μP), a microcontroller (μC), or a digital signal processor (DSP), among others. A memory controller 1015 can also be used with the processor 1010, or in some implementations, the memory controller 1015 can be an internal part of the processor 1010.

Depending on the desired configuration, the system memory 1020 can be of any type, including volatile memory (such as RAM) and non-volatile memory (such as ROM, flash memory). The system memory 1020 can include one or more applications 1022 and program data 1024. The application(s) 1022 can include an index algorithm 1023 that is arranged to provide inputs to the electronic circuits. The program data 1024 can include content information 1025 that can be directed to any number of types of data. The application 1022 can be arranged to operate with the program data 1024 on an operating system.

The computer system 1000 can have additional features or functionality, and additional interfaces to facilitate communication between the basic configuration 1002 and any devices and interfaces. For example, data storage devices 1040 can be provided including removable storage devices 1042, non-removable storage devices 1044, or both. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives. Computer storage media can include volatile and nonvolatile, non-transitory, removable and non-removable media implemented in any method or technology for storage of information, such as computer readable instructions, data structures, program modules, or other data.

The system memory 1020 and the storage devices 1040 are examples of computer storage media. Computer storage media includes, but is not limited to, RAM, ROM, EEPROM, flash memory or other memory technology, CD-ROM, DVDs or other optical storage, magnetic cassettes, magnetic tape, magnetic disk storage or other magnetic storage devices, or any other medium that can be used to store the desired information and that can be accessed by the computer system 1000.

The computer system 1000 can also include output interfaces 1050 that can include a graphics processing unit 1052, which can be configured to communicate with various external devices, such as display devices 1090 or speakers by way of one or more A/V ports or a communication interface 1070. The communication interface 1070 can include a network controller 1072, which can be arranged to facilitate communication with one or more other computer systems 1080 over a network communication by way of one or more communication ports 1074. The communication connection is one example of a communication media. Communication media can be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR), and other wireless media.

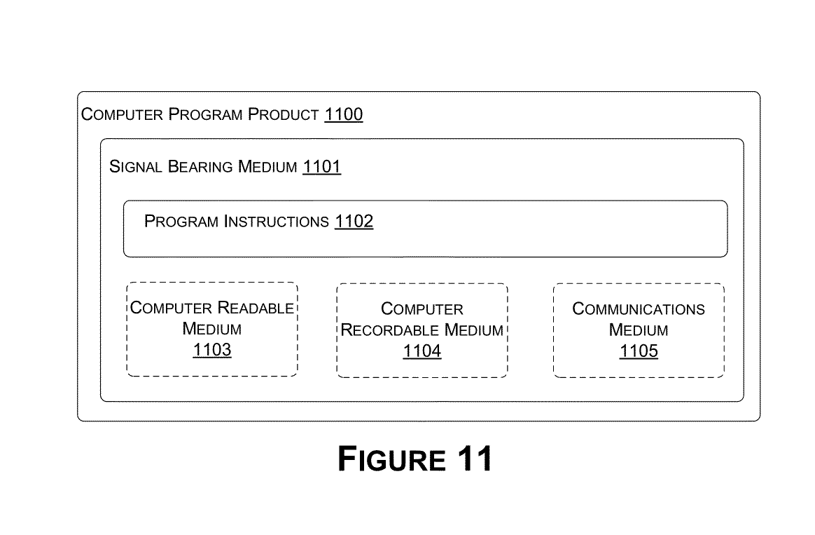

The disclosed methods can be implemented as computer program instructions encoded on one or more non-transitory computer-readable storage mediums in a machine-readable format, or on other non-transitory media or articles of manufacture. FIG. 11 illustrates a conceptual partial view of an exemplary computer program product 1100 that includes a computer program for executing a computer process on a computer system or computing device, arranged according to some disclosed implementations.

The computer program product 1100 is provided using a signal bearing medium 1101. The signal bearing medium 1101 can include one or more programming instructions 1102 that, when executed by one or more processors, can provide functionality or portions of the functionality discussed above in connection with FIGS. 8 and 9. In some implementations, the signal bearing medium 1101 can encompass a computer-readable medium 1103 such as, but not limited to, a hard disk drive, a CD, a DVD, a digital tape, or memory. In some implementations, the signal bearing medium 1101 can encompass a computer-recordable medium 1104 such as, but not limited to, memory, read/write (R/W) CDs, or R/W DVDs. In some implementations, the signal bearing medium 1101 can encompass a communications medium 1105 such as, but not limited to, a digital or analog communication medium (for example, a fiber optic cable, a waveguide, a wired communications link, or a wireless communication link). Thus, for example, the signal bearing medium 1101 can be conveyed by a wireless form of the communications medium 1105 (for example, a wireless communications medium conforming with the IEEE 802.11 standard or other transmission protocol).

The one or more programming instructions 1102 can be, for example, computer executable or logic implemented instructions. A computer system (such as the computer system 1000 of FIG. 10) can be configured to provide various operations, functions, or actions in response to the programming instructions 1102 conveyed to the computer system by one or more of the computer-readable medium 1103, the computer recordable medium 1104, and the communications medium 1105.

### CONCLUSION

While various examples and embodiments have been disclosed, other examples and embodiments will be apparent to those skilled in the art. The various disclosed examples and embodiments are for purposes of illustration and are not intended to be limiting, with the true scope and spirit being indicated by the following claims.

What is claimed is:

1. A method comprising:
making a first label for use in a molding assembly of an in-mold labeling apparatus, wherein making the first label comprises:
advancing a first portion from rolled labeling material to a label making area of the in-mold labeling apparatus,
printing first label information on the first portion, and
cutting the first portion, wherein cutting the first portion comprises applying a first laser beam to the first portion based on a first pattern; and
making a second label for use in the molding assembly, wherein making the second label comprises:
advancing a second portion from the rolled labeling material to the label making area,
printing second label information on the second portion, and
cutting the second portion, wherein cutting the second portion comprises applying a second laser beam to the second portion based on a second pattern, and wherein the second pattern is different from the first pattern.

2. The method of claim 1, wherein:
cutting the first portion further comprises applying the first laser beam along a perimeter of the first portion;
cutting the second portion comprises applying the second laser beam along a perimeter of the second portion; and
the perimeter of the first portion is different from the perimeter of the second portion.

3. The method of claim 1, wherein:
the rolled labeling material comprises a first roll and a second roll;
the first portion is from the first roll; and
the second portion is from the second roll.

4. The method of claim 1, wherein:
the rolled labeling material comprises a roll; and
the first portion and the second portion are from the roll.

5. The method of claim 1, wherein:
the first portion is formed of a first material;
the second portion is formed of a second material; and
the first material is different from the second material.

6. The method of claim 1, further comprising:
receiving shape information that is indicative of a shape of an object for use in the second in-mold labeling; and
determining the second pattern based on the shape information.

7. The method of claim 1, wherein the first label information is different from the second label information.

8. The method of claim 1, further comprising performing an in-mold labeling using the cut first portion and the cut second portion.

9. The method of claim 1, wherein making the first label and making the second label temporally overlap.

10. An apparatus comprising:
a printer roll assembly, the printer roll assembly being configured to receive rolled labeling material;
a printer assembly, the printer assembly including a printer, the printer being configured to print at least one of a plurality of different labels onto a portion of the labeling material; and
a laser device assembly, the laser device assembly being configured to provide a laser beam to cut the portion into a cut portion for insertion into a mold cavity, the laser device assembly being programmable to cut a plurality of shapes.

11. The apparatus of claim 10, further comprising a roll feeder assembly, the roll feeder assembly being configured to feed the portion from the printer assembly to a laser target area, wherein the laser assembly is configured to provide the laser beam at the laser target area.

12. The apparatus of claim 10, further comprising a laser target area and a suction plate disposed at the laser target area, the suction plate being configured to generate a suction for holding the portion of the labeling material at the target area, the suction plate being further configured to receive a fume that results from use of the laser beam.

13. The apparatus of claim 10, wherein the laser device assembly comprises:
a laser configured to provide the laser beam; and
a scan head configured to receive the laser beam and to direct the laser beam toward a laser target area.

14. The apparatus of claim 10, further comprising a pick and place assembly, the pick and place assembly being configured to pick up the cut portion, and to place the cut portion onto a component that is to deliver the cut portion to a molding assembly.

15. The apparatus of claim 14, wherein the component includes a robotic arm assembly, the robotic arm assembly being configured to deliver the cut portion to the molding assembly.

16. The apparatus of claim 10, further comprising a molding assembly, the molding assembly including a mold, the mold including the mold cavity, the mold cavity being configured to receive the cut portion, the molding assembly being further configured to perform an in-mold labeling using the cut portion.

17. A computer system comprising:
one or more non-transitory computer-readable mediums; and
program instructions that are stored to the one or more non-transitory computer-readable mediums and executable by one or more processors to cause an in-mold labeling apparatus to perform functions comprising:
advancing a labeling portion from rolled labeling material to a cutting area of the in-mold labeling apparatus, wherein label information is printed on the labeling portion;
controlling a laser beam to cut the labeling portion based on a pattern received by the computer system, wherein cutting the labeling portion comprises applying the laser beam to the labeling portion; and
performing an in-mold labeling using the labeling portion.

18. The computer system of claim 17, wherein the functions further comprise causing a printing assembly to print the label information on the labeling portion.

19. The computer system of claim 17, wherein cutting the labeling portion further comprises selecting the pattern from a plurality of laser patterns.

20. The computer system of claim 17, wherein the functions further comprise:
receiving information that is indicative of a shape of an object for use in the in-mold labeling; and
determining the pattern based on the shape information.
